(19) United States
(12) Patent Application Publication
(10) Pub. No.: US 2004/0072668 A1
(43) Pub. Date: Apr. 15, 2004

(54) Liquid phase discharge port incorporating chamber nozzle device for centrifuge

(75) Inventor: Woon-Fong Leung, Sherbon, MA (US)

Correspondence Address: R. Neil Sudol, 714 Colorado Avenue, Bridgeport, CT, 06605, US

(73) Assignee: Baker Hughes Incorporated, Houston, TX (US)

(21) Appl. No.: 10/357,133

(22) Filed: Feb. 3, 2003

Related U.S. Application Data
(60) Provisional application No. 60/418,500, filed on Oct. 15, 2002.

(51) Int. Cl. B04B 11/02

(52) U.S. Cl. 494/56

(57) ABSTRACT

In a rotating machine, at least one liquid phase discharge port assembly is provided on the bowl. The bowl is rotatable about an axis to generate a cylindrical pool of a feed slurry. The discharge port assembly includes at least one fluid guide member mounted at least indirectly to the bowl to define a liquid phase discharge path having no bends or turns, with a circumferential component oriented in opposition to a direction of rotation of the bowl.

### BACKGROUND OF THE INVENTION

This invention relates to a rotating machine such as a centrifuge. More particularly, this invention relates to a liquid phase discharge port for a rotating machine such as a centrifuge. This invention also relates to an associated method of effluent discharge from a rotating machine.

In bowl of a decanter centrifuge, solid-liquid separation takes place in a rotating pool that is maintained by a set of semi-circular weirs. The settled solid cake (hereafter referred as heavy phase) is conveyed toward a conical beach at one end of the rotating bowl by a screw conveyor, which rotates at a differential speed compared with the bowl, while the clarified liquid containing unsettled fine solids or the light phase (hereafter simply referred as liquid or liquid phase) overflows the weirs at the large end of the machine opposite the conical beach.

It is well known that a portion of the total hydraulic power consumed during operation of a centrifuge is wasted as kinetic energy of the discharged effluent liquid and the remaining portion wasted in dissipation. The total hydraulic power consumed is proportional to the density of the clarified liquid, the volumetric flow rate of the liquid, the rotational speed of the bowl to the second power, and the discharge radius of the pool to the second power. To that end, it is important to operate the centrifuge with the lowest possible speed and centrifugal gravity while still achieving process separation.

Another problem in centrifuge operation is related to pool level adjustment. There may be geometric constraints at the effluent bowl head, which limit the radius of the weirs. This problem is especially acute when the pool is deep especially at spill point of the conical beach.

The physical principle of using reaction torque from a discharged high-velocity jet is well known but has not been successfully implemented to recover power from decanter centrifuges. For example, U.S. Pat. No. 5,147,277 discusses a vane apparatus wherein the clarified effluent leaving an opening of the bowl head is channeled into a plurality of channels formed by adjacent vanes. The flow turns from an axial direction to a radially inward direction along the vanes. As the fluid reaches the smaller radius of the vane apparatus, it is redirected by the vanes to flow circumferentially in a direction opposite to the direction of rotation of the centrifuge bowl.

The discharge radius of the vane apparatus of U.S. Pat. No. 5,147,277 is small to conserve power and the discharge radius is approximately at the spillover radius of the conical beach. This design incurs high pressure or head loss due to (1) friction from the large surface area of the vanes with which the discharging fluid is in contact, and (2) the two 90-degree turns made by the discharging fluid—first as the flow leaves the bowl guided by the vanes towards a small radius and second at the small radius where the flow is deflected from a radial inward direction to a circumferential direction. This head loss is disadvantageously very high, resulting in a pool elevation substantially above the spillover at the conical beach. Thus, a majority of the flow spills at the conical beach, resulting in process upset (wet cake for deliquoring applications and/or dilute underflow for thickening applications). Concurrently there is less flow reporting to the vane apparatus resulting in little power savings.

Instead of vanes, it is possible to use a 90-degree elbow in a power recovery assembly wherein a discharge nozzle is directed in a circumferential direction opposite to the rotation direction. As with the vane apparatus of U.S. Pat. No. 5,147,277, there is significant pressure or head loss when the flow has to make a 90-degree turn especially under rotation. Many complicated secondary-flow patterns can be generated especially in rotating flow, resulting in further energy loss and power dissipation. In addition, high wear would be expected in local regions as the flow makes a turn. This wear would become a serious problem when the effluent contains even a small amount of abrasive solids.

It is possible to use larger-diameter tubes to increase the cross sectional area of the elbow, thus reducing the relative velocity of flow through the elbow and piping. Unfortunately, the large piping would also present a large exterior surface area where discharged jets from preceding nozzles would interfere/hit with succeeding nozzles, resulting in misting, re-acceleration and additional wind drag.

Along the same design approach as the elbow, two-90 degree turns of piping could be arranged where the flow exiting the bowl head port is first directed radially to a different radius and subsequently at this new radius the flow is redirected in a circumferential direction opposite to rotation. The performance in this case would be similar to that of the vane apparatus of U.S. Pat. No. 5,147,277 in that head loss from the two 90-turns incurs excessive pressure loss resulting in little or no power savings from this device.

There is another pressure loss that is of concern. When flow is channeled into a nozzle, the fluid is rapidly accelerated to a high velocity as the flow area is significantly reduced from the clarifier toward the ports of the bowl head and subsequently to the elbow inlet. This head/pressure loss due to converging flow at inlet/entrance of the flow path at the vicinity of the port/opening of the bowl head can be significant.

Also, with a 90-degree elbow bend in order to get a smooth flow with reduced energy dissipation in the elbow, a large radius of curvature is required for the elbow, which means the elbow would have to protrude quite a distance beyond the face of the mounting flange. This exposes the elbow to higher wind drag and interference with the discharged jet resulting in higher power.

### SUMMARY OF THE INVENTION

A rotating machine comprises, in accordance with the present invention, a bowl and at least one liquid phase discharge port assembly provided on the bowl. The bowl is rotatable about an axis to generate a cylindrical pool of a feed slurry and is provided with a heavy phase discharge port. The liquid phase discharge port assembly includes at least one fluid guide member mounted at least indirectly to the bowl to define a liquid phase discharge path having no bends or turns, with a circumferential component oriented in opposition to a direction of rotation of the bowl.

The present invention reduces power losses due to turbulence and circulation eddies. In part because there are no bends or turns along the liquid phase discharge path, turbulence and circulation eddies are reduced, if not eliminated.

Where the bowl includes a bowl head or end wall disposed in a plane oriented substantially perpendicularly to an axis of rotation of the bowl, the liquid phase discharge port assembly may include a casing disposed on the head or end wall to define a chamber in fluid communication with the pool, the fluid guide member being connected to the casing for communication with the chamber. The cross sectional area of the chamber is preferably much larger than that of the fluid guide member and as a result there is no rapid acceleration of the fluid as the flow from the clarifier or cylinder enters the chamber. In view of these factors, the head and pressure loss with the present invention is significantly reduced.

In one embodiment of the present invention, the casing is connected directly and rigidly to the head or end wall (e.g., via a flange and bolts) so as to be integral therewith. In another embodiment of the invention, the casing is provided on a weir plate removably fastened to the head or end wall. Pursuant to another feature of the present invention, the weir plate is formed with a straight or arcuate edge defining at least one pool spill radius. More specifically, the edge may be formed along a side of a cutout in the weir plate. Alternatively, the pool-spill edge may be a peripheral edge of the weir plate or of an insert plate disposed adjacent to the weir plate. The insert plate may have an adjustable position relative to the weir plate and the head or end wall, whereby the pool spill radius may be adjusted.

In accordance with a further feature of the present invention, the fluid guide member is disposed on the chamber casing so that the liquid phase discharge path is oriented at an acute angle to the plane of the bowl head. Preferably, this acute angle is less than 45 degrees. More preferably, the angle is between 10 and 20 degrees. This angling of the fluid guide member avoids interference between the discharged liquid jet and the rotating surfaces such as bowl head and weir plate. Also this eliminates reacceleration of the liquid jet by the rotating surfaces, which leads to higher power consumption. Where the fluid guide member is a nozzle, the inlet to the fluid guide member may be chamfered to reduce losses at the inlet so that the flow can smoothly accelerate from a larger nozzle diameter to a smaller nozzle diameter at a much higher velocity without pressure loss.

In accordance with an optional feature of the present invention, the casing is provided with an aerodynamic contour or profile. The aerodynamic contour or profile may include an outer surface of the casing oriented at an acute angle relative to an outer surface of the head or end wall. Preferably, the chamber casing is aerodynamic on all edges and faces to reduce wind drag and reacceleration of discharged liquid phase.

Preferably, the chamber in the casing has such a size, relative to a passageway of the fluid guide member, that fluid in the chamber is in substantial equilibrium with the slurry pool. Thus, the chamber may form an extension of the slurry pool.

Where the casing defines a shoulder on the head or end wall of the bowl, the fluid guide member may be connected to the casing at the shoulder.

Where the casing has an inner wall on a radially outer side of the chamber, the inner wall may be sloped down towards the pool to facilitate self-cleaning of the chamber by a component of the centrifugal gravity.

The casing and the inner wall of the chamber are preferably made of wear resistant material.

The fluid guide member may be a nozzle, for instance, with a passageway of gradually decreasing diameter to reduce pressure loss. Alternatively, the fluid guide member may have a passageway with a downstream section of substantially constant cross-sectional area and of sufficient length so that discharging liquid is accelerated to a final discharge velocity so as to obtain a coherent jet of discharging liquid with reduced spreading. Spreading is undesirable because it reduces the average velocity of the discharged jet and increases the probability of recontacting a rotating surface.

The fluid guide member may be permanently fixed or removably mounted to the bowl. Preferably, the fluid guide member is made of wear resistant material.

The present invention involves power use minimization and conservation. In another aspect of the present invention, power is conserved by channeling the flow of liquid effluent at the outlet of the fluid guide member. Specifically, where a stationary case wall is spaced from the bowl at least in a region of the liquid phase discharge port assembly, at least one stationary annular baffle with an opening at the center is disposed between the case wall and the bowl, with the liquid phase discharge path being directed into a compartment or gutter between the case wall and the baffle to thereby prevent impingement of discharged liquid onto an outer surface of the bowl and concomitantly prevent an imparting of kinetic energy to the discharged liquid by the rotating bowl. This is particularly beneficial when the rotor surface is very close to the case wall, and when the discharge radius is small, exposing a large surface area of the bowl head. The baffle system minimizes power consumption. The compartment or gutter can be used with a standard weir or with a power recovery device using discharging liquid jet at high velocity. The baffle also reduces the large volume of air mass with which the rotating bowl head is in contact with thus reducing wind drag of the system and most importantly the reacceleration of the mist or atomized liquid droplets formed as the discharged effluent liquid with high velocity and kinetic energy is abruptly stopped by the stationary casing.

Preferably, the baffle is disposed in a plane oriented substantially perpendicularly to a rotation axis of the bowl and extends in a radial direction outwardly from a discharge opening of the discharge device. An additional stationary baffle optionally disposed at a radially outer end of the one baffle may have an arcuate shape and may be attached to the one baffle to prevent recontact of discharged liquid with the outer diameter of the rotating bowl. The case wall and/or the baffle may be made at least partially of a shock-absorbing material such as an elastomer that captures energy from the discharged liquid phase.

Pursuant to a selected embodiment of the present invention, a rotating machine comprises a bowl and at least one liquid phase discharge port assembly carried by a head or end wall of the bowl to define a chamber communicating with a cylindrical slurry pool. The bowl is rotatable about an axis to generate the slurry pool and has a heavy phase discharge port. The port assembly includes a fluid guide member mounted at least indirectly to the bowl and communicating with the chamber. The fluid guide member extends at least partially in a circumferential direction opposed to a direction of rotation of the bowl.

As discussed above, the liquid phase discharge port assembly may include a weir plate defining the chamber and removably fastened to the head or end wall of the bowl. The weir plate may be provided with a straight or arcuate edge defining at least one pool spill radius. The pool-spill edge may be formed as a peripheral edge of the weir plate, as an internal edge thereof (cutout edge), or as an edge of an insert plate disposed adjacent to the weir plate. The insert plate may be movably mounted to the weir plate and the head or end wall of the centrifuge bowl, whereby the pool spill radius may be adjusted.

Where the liquid phase discharge port assembly includes a casing connected directly or indirectly (e.g., via a weir plate) to the head or end wall and defining the chamber, the fluid guide member may be attached to the casing. As discussed above, the casing may provided with an aerodynamic contour or profile, which may include an outer surface of the casing oriented at an acute angle relative to an outer surface of the head or end wall. Where the chamber is an extension of the pool and defines a shoulder on the head or end wall, the fluid guide member may be connected to the casing at the shoulder.

Again, the fluid guide member may be a nozzle and may be oriented at an acute angle of less than 45 degrees and preferably between 10 and 20 degrees relative to the head or end wall of the bowl.

The chamber may be disposed on a side of the bowl head or end wall opposite the pool. In this case, the chamber is likely defined by a casing attached to an outer surface of the bowl head or end wall. Alternatively, the chamber may be disposed inside the head or end wall.

A liquid-phase discharge port assembly for a rotating machine producing a liquid phase from a feed slurry comprises, in accordance with the present invention, a weir plate adapted for placement over a discharge opening in a bowl of the rotating machine, and at least one power recovery device attached to the weir plate. The weir plate may be formed with a straight or arcuate, peripheral or internal (cutout) edge defining at least one pool spill radius.

The power recovery device can take any of a number of different forms, for instance, a chamber and nozzle design or a 90-degree elbow. In the former alternative, a casing on the weir plate defines a chamber along the one side of the weir plate and the power recovery device includes a straight fluid guide member such as a nozzle member, the nozzle member communicating at an upstream end with the chamber. The chamber preferably has such a size, relative to a passageway of the fluid guide member, that fluid in the chamber flows smoothly, without significant pressure loss due to turbulence and circulation eddies, during a discharge of fluid through the fluid guide member.

Pursuant to a supplementary feature of the present invention, the weir plate covers the discharge opening completely, whereby discharging liquid phase must exit through the power recovery device. Alternatively, the weir plate may have an overflow port to allow a small amount of liquid discharge so that the pool has a maximum depth and a maximum pressure difference is established for discharging the effluent through the power recovery device. In case the overflow port discharge radius needs to be changed, an adjustable mechanism can be used to adjust the discharge radius of the overflow port of the weir. The power recovery device and the weir plate can take form as a casting with a shape that is most optimal to flow. The nozzle and other detachable parts (including the chamber or elbow) are replaceable for optimization for a given process or for repair of eroded parts.

A liquid-phase discharge port assembly for a rotating machine producing a liquid phase from a feed slurry comprises, in accordance with another embodiment of the present invention, (1) a casing adapted for attachment to a bowl of the rotating machine to define a chamber communicating with a pool of feed slurry in the bowl and (2) at least one fluid guide member rigidly mounted to the casing so as to communicate with the chamber. The chamber has such a size, relative to a passageway of the fluid guide member, that fluid in the chamber is in substantial equilibrium with the pool. The fluid guide member is preferably attached to the casing and includes at least one linear tube segment extending from the weir plate to define a liquid phase discharge path having no bends or turns.

A method for operating a rotating machine comprises, in accordance with the present invention, feeding a slurry to a bowl, rotating the bowl about an axis to generate a cylindrical pool of the feed slurry, discharging a heavy phase from the bowl via a discharge port during the rotating of the bowl, and also during the rotating of the bowl, discharging a liquid phase through a nozzle on the bowl and along a liquid phase discharge path having no bends or turns, with a circumferential component oriented in opposition to a direction of rotation of the bowl.

A method for operating a rotating machine to produce a liquid phase from a feed slurry comprises, in accordance with another aspect of the present invention, providing a liquid-phase discharge port assembly including a weir plate, attaching the weir plate to a bowl of the rotating machine over a discharge opening in the bowl, feeding a slurry to the bowl, rotating the bowl about an axis to generate a cylindrical pool of the feed slurry, discharging a heavy phase from the bowl via a discharge port during the rotating of the bowl, and discharging a liquid phase through at least one power recovery device attached to the weir plate during the rotating of the bowl.

A method for operating a rotating machine comprises, in accordance with yet another aspect of the present invention, feeding a slurry to the bowl, rotating the bowl about an axis to generate a cylindrical pool of the feed slurry, discharging a heavy phase from the bowl via a discharge port during the rotating of the bowl, and also during the rotating of the bowl, discharging a liquid phase into a gutter defined between a stationary case wall spaced from the bowl and at least one stationary baffle disposed between the case wall and the bowl, thereby preventing impingement of the discharged liquid phase and mist (or atomized liquid droplets) formed onto an outer surface of the bowl and concomitantly preventing an imparting of kinetic energy to the discharged liquid by the rotating bowl.

In a liquid phase discharge assembly in accordance with the present invention, clarified liquid first flows into a chamber which is in equilibrium with the rotating pool in the clarifier. The liquid is subsequently accelerated to a high jet velocity through a nozzle before discharge by the liquid head difference between the pool surface and the nozzle. Given the flow is not making any turns along the discharge path, the head loss associated with this is effectively eliminated. Also the erosion of machine parts due to the high shear stress at flow turning points and the high flow velocity through the nozzle is minimized. The chamber dimension along the axial direction (height) is small compared with the other two dimensions (width and length) perpendicular to the axis so that when a casing defining the chamber is bolted/mounted onto the bowl head, additional wind drag is not significant. Also this “low-profile” chamber does not interfere with the discharged jets from preceding chambers.

Generally, the fluid guide member (e.g., nozzle) is disposed at a radius larger than that of the surface of the liquid pool. The pressure difference between these two radii provides a driving force that is sufficient to accelerate the discharging liquid in a liquid jet at a high velocity. In essence a liquid phase discharge port assembly in accordance with the present invention converts the pressure head into kinetic energy to discharge a high jet velocity in a direction opposite to the bowl rotation direction with minimal head loss. The discharged jet generates a reaction force. The sum of multiple such reaction forces from liquid jets discharged from a plurality of nozzles spaced circumferentially along the bowl head and all of which are acting approximately tangentially at a radius from the axis of the machine sum up to a net reaction torque to drive the rotor in the opposite direction, i.e., in the direction of rotation of the rotor. This net reaction torque reduces both the applied torque and power necessary to turn the rotor at the same speed and feed rate. Substantial savings in hydraulic power of between 10% and 40% can be realized with the present new invention.

### BRIEF DESCRIPTION OF THE DRAWINGS

FIG. 1 is a highly schematic partial perspective view of a conventional decanter centrifuge bowl.

FIG. 2 is a similarly schematic longitudinal cross-sectional view taken along line II-II in FIG. 1.

FIG. 3A is a schematic longitudinal cross-sectional view of a decanter centrifuge bowl with a power recovery device of the prior art.

FIG. 3B is a schematic partial cross-sectional view taken along line IIIB-IIIB in FIG. 3A.

FIG. 3C is a schematic partial cross-sectional view taken along line IIIA-IIIA in FIG. 3A.

FIG. 4A is a schematic longitudinal cross-sectional view of a decanter centrifuge bowl with a liquid phase discharge port assembly in accordance with the present invention.

FIG. 4B is a schematic longitudinal cross-sectional view showing a modification of the liquid phase discharge port assembly of FIG. 4A.

FIG. 4C is a schematic longitudinal cross-sectional view showing a modification of the decanter centrifuge bowl and liquid phase discharge port assembly of FIG. 4A.

FIG. 4D is a schematic longitudinal cross-sectional view of a decanter centrifuge bowl with a liquid phase discharge flow guide in accordance with the present invention.

FIG. 5A is a partial cross-sectional view through a head or end wall of a decanter centrifuge, showing a liquid phase discharge port assembly with a chamber and a nozzle, in accordance with the present invention.

FIG. 5B is a partial cross-sectional view through a head or end wall of a decanter centrifuge, showing another liquid phase discharge port assembly with a chamber and a nozzle, in accordance with the present invention.

FIG. 5C is a schematic partial cross-sectional view taken along line VC-VC in FIG. 5B.

FIG. 6 is a partial cross-sectional view through a head or end wall of a decanter centrifuge, taken along a substantially radial plane, showing another liquid phase discharge port assembly with a chamber and a nozzle, in accordance with the present invention.

FIG. 7A is a front view of a weir plate for covering a liquid phase discharge port in a centrifuge bowl head, pursuant to the prior art.

FIG. 7B is a schematic partial elevational view of a centrifuge bowl head with the weir plate of FIG. 7A attached thereto.

FIG. 7C is a schematic partial cross-sectional view taken along line VIIC-VIIC in FIG. 7B.

FIG. 8A is a front elevational view of a weir plate with a chamber casing and a discharge nozzle, in accordance with the present invention.

FIG. 8B is a front elevational view of another weir plate with a chamber casing and a discharge nozzle, in accordance with the present invention.

FIG. 9A is a schematic partial elevational view of a centrifuge bowl head with the weir plate of FIGS. 8A and 8B attached thereto.

FIG. 9B is a schematic partial cross-sectional view taken along line IXB-IXB in FIG. 9A.

FIG. 9C is a schematic cross-sectional view similar to FIG. 9B, showing a conical beach section of a centrifuge bowl and different pool levels corresponding to different weir spill levels.

FIG. 10A is a front elevational view of a weir plate with a modified chamber casing and discharge nozzle, in accordance with the present invention, attached to a centrifuge bowl head.

FIG. 10B is a schematic partial cross-sectional view taken along line XB-XB in FIG. 10A.

FIG. 11A is a front elevational view of a weir plate with another modified chamber casing and discharge nozzle, in accordance with the present invention, attached to a centrifuge bowl head and including a weir plate insert or extension.

FIG. 11B is a schematic partial cross-sectional view taken along line XIB-XIB in FIG. 11A.

FIG. 12A is a schematic partial cross-sectional view, taken in a generally radial plane, of a centrifuge bowl with a case wall and baffle for channeling discharged liquid phase from a discharge port in a bowl head.

FIG. 12B is a view similar to FIG. 12A, showing a modification comprising additional baffles in accordance with the present invention.

FIG. 12C is a view similar to FIG. 12B, showing the additional of a discharge port assembly in accordance with the present invention.

FIG. 12D is another generally radial partial cross-sectional view, similar to FIG. 12C, but taken at an upper side of a centrifuge machine.

FIG. 13A is a longitudinal cross-sectional view of a nozzle assembly utilizable in a liquid phase discharge port assembly in accordance with the present invention.

FIG. 13B is a front elevational view of the nozzle assembly of FIG. 13A, taken from the right side in that drawing figure.

FIG. 14 is a partial cross-sectional view of a bowl head or end wall of a centrifuge, showing a liquid phase discharge port device in accordance with the present invention.

FIG. 15 is a cross-sectional view of another liquid phase discharge port assembly in accordance with the present invention.

In the drawing figures, like reference numerals designate like structural features.

### Definitions

The term “liquid phase” is used herein to designate a light phase produced during centrifugation. A liquid phase may include solids or particulate matter suspended in a liquid carrier. The term “heavy phase” is used to denote a cake-like sediment produced during centrifugation.

The term “liquid phase discharge path” refers herein to a trajectory of a liquid phase upon exiting an outlet port in a discharge port assembly. A discharge path thus extends from a liquid phase discharge outlet in a space outside of a rotating machine such as a centrifuge bowl.

### DETAILED DESCRIPTION OF THE PREFERRED EMBODIMENTS

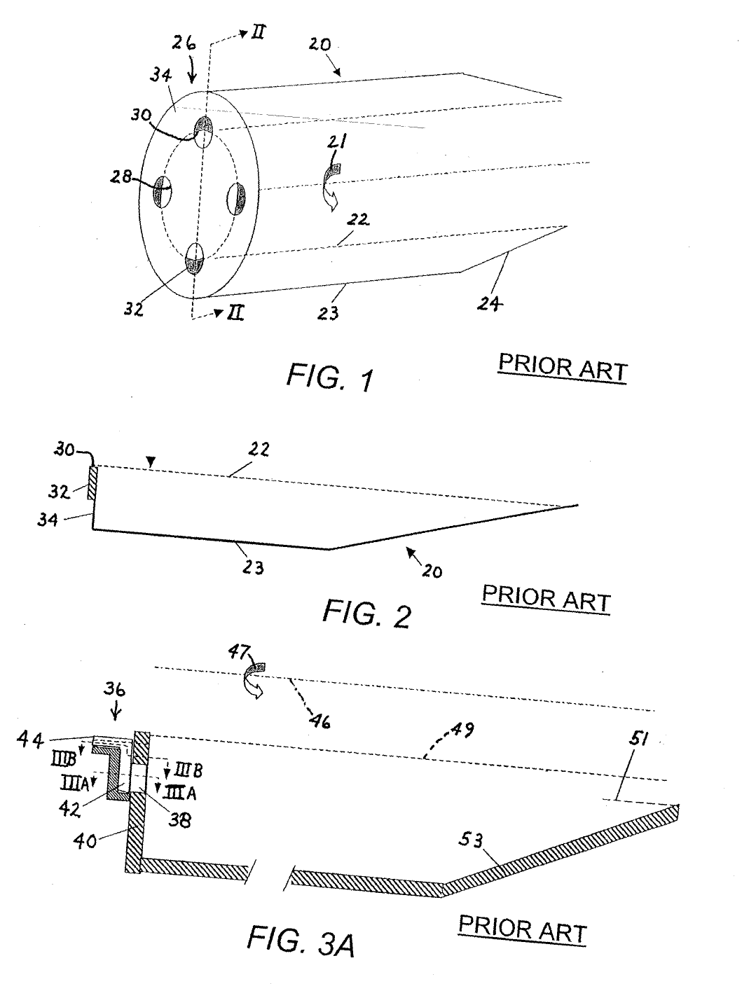

FIGS. 1 and 2 are diagrams of a bowl 20 of a conventional decanter centrifuge. For simplicity, the conveyor, feed system and drives are not shown. A feed slurry is introduced into a separation pool 22 after the bowl has been accelerated to a predetermined angular velocity indicated by a curved arrow 21. In the pool 22, the heavier solids settle in a clarifier 23 to form a concentrated underflow or cake (not shown) that is transported up a conical beach 24 by a differential rotation between the conveyor and bowl 20, while the clarified liquid free from solids overflows at a large end 26 of the bowl 20 through a discrete set of ports 28. The pool depth D1 in the decanter bowl 20 is determined by the radial location of spill edges 30 of respective weir plates 32 attached to a bowl head 34 at the large end of the bowl.

Pool depth D1 may be set via weir plates 32. By using weir plates 32 of different sizes, the radius corresponding to the depth D1 of the pool can be adjusted for optimization for a given process application. For thickening of municipal sludge from 0.3-1% solids to 4-6% underflow with minimal solids in the effluent liquid, the pool depth D1 is set as deep as possible to reduce the radius of discharge and thus the hydraulic power consumed. The power consumed is proportional to the product of speed and discharge radius to the second power and the first power of the flow rate. Thus, a smaller liquid discharge radius reduces also the hydraulic power component, which is a major contributor to power consumption in some process applications especially those that require high volumetric feed rate.

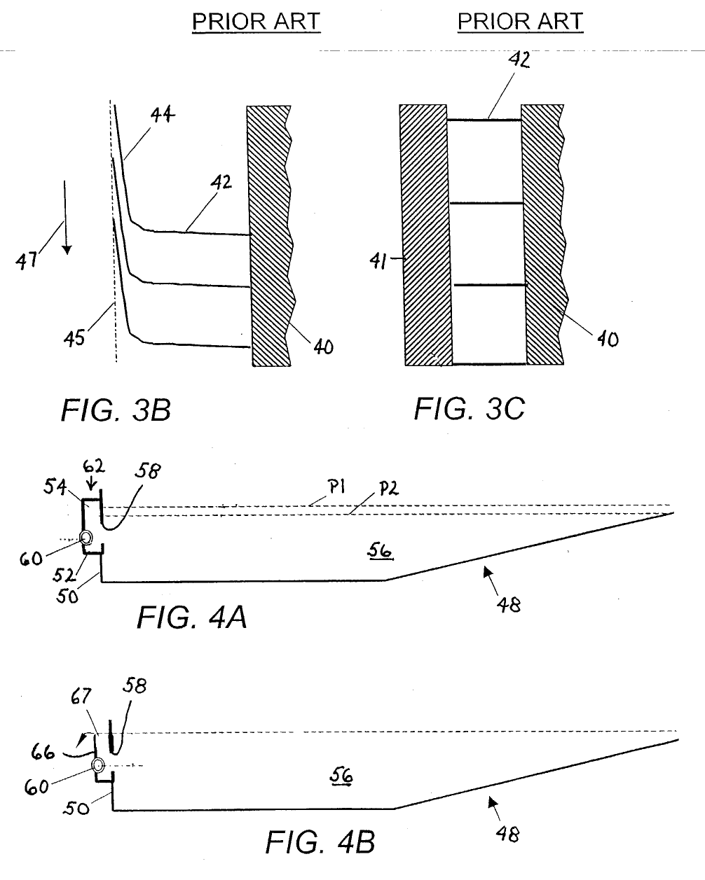

A turning-vane apparatus 36 as disclosed in U.S. Pat. No. 5,147,277 is shown in FIG. 3A. Clarified flow from a port 38 of a bowl head 40 is channeled into the turning vane apparatus 36, which comprises a plurality of channels formed by radial vane sections 42 and respective circumferential vane sections 44. Radial vane section are disposed between bowl head 40 and a wall 41 pf the turning vane apparatus 36. The liquid phase flow is first directed radially inward toward a bowl rotation axis 46 and then circumferentially in a direction opposite to the direction of bowl rotation. As depicted in FIG. 3C, at the upstream end of turning-vane apparatus 36, the vanes are straight and radial directing the flow radially inward from an original axial flow orientation at the inlet of the apparatus. FIG. 3B shows that the flow reaching the smaller radius at the downstream side of the turning-vane apparatus 36 is redirected in an exit plane 45 in a direction opposite to the direction of rotation 47. The pressure drop required for the device where flow has to make two 90-degree turns is large and given the discharge radius of the device is very close to the pool surface or level 49, the pool level upstream can be significant. Indeed FIG. 3A depicts that the pool level 49 could very well be higher compared with the spill point 51 of the conical beach 53. This causes an increasing fraction of underflow to discharge at the conical discharge or spill point 51, reducing the consistency of that stream. Also the apparatus might not be able to establish a high jet velocity to minimize power consumption because of the large pressure loss associated with this design.

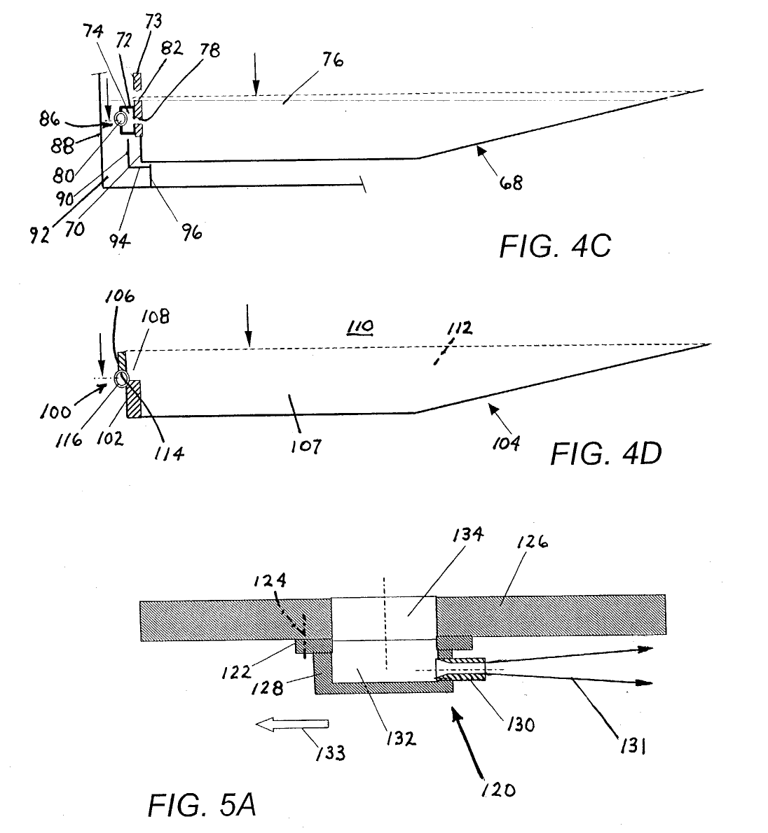

As illustrated in FIG. 4A, a decanter centrifuge includes a bowl 48 having a head or end wall 50 provided along an outer side with a casing 52. Casing 52 may be permanently or removably connected to head or end wall 50, for example, by a flange (not shown) and bolts (not shown). Casing 52 defines a chamber 54 that communicates with a cylindrical slurry pool 56 inside bowl 48 via an opening 58. Chamber 54 holds liquid phase (not separately designated) in equilibrium with the slurry of pool 56. Liquid phase exits chamber 54 via a tubular fluid guide member 60 in the form of a nozzle. The term “fluid guide member” is used herein to designate a pipe, tube, duct, conduit, channel, or nozzle defining a passageway along which fluid may flow from a slurry pool in a centrifuge. The passageway may be of substantially uniform cross-sectional area from an upstream end to a discharge opening at a downstream end. Alternatively, the cross-section of the guide member's passageway may change from the upstream end to the downstream end. For instance, where it is desired to increase the momentum of the discharging liquid phase, a nozzle with a converging passageway may be utilized.

The depth of pool 56 is set by the diameter of nozzle 60. It is to be noted that only one nozzle is shown in FIG. 4B; in practice, however, multiple nozzles are spaced angularly around the circumference of head o end wall 50. Pool level P1 (deeper pool) and pool level P2 (shallower pool) are obtained with use of a nozzle 60 of relatively small and relatively large diameter, respectively. Nozzle 60 communicates at an upstream end with chamber 54 and is directed in an at least partially circumferential direction opposite to the direction of bowl rotation. A jet of fluid discharged via nozzle 60 thus provides motive power to assist in the rotation of bowl 48. Casing 52 and nozzle 60 represent a liquid phase discharge port assembly 62 that is preferably provided in multiple instances at circumferentially spaced locations about head or end wall 50.

FIG. 4B illustrates a liquid phase discharge port assembly 64 similar to port assembly 62 except that a casing 66 of port assembly 64 is provided with an overflow opening 67 on the radially inner side, i.e., at the small radius.

As depicted in FIG. 4C, a decanter centrifuge includes a bowl 68 having a head or end wall 70 provided along an outer side with a casing 72. Casing 72 is rigidly fixed to head or end wall 70, for example, by a flange (not shown) and bolts (not shown) or by a weir plate 73. Casing 72 defines a chamber 74 that communicates with a cylindrical slurry pool 76 inside bowl 68 via an opening 78. Chamber 74 holds liquid phase (not separately designated) in equilibrium with the slurry of pool 76. Liquid phase exits chamber 74 via a tubular fluid guide member 80 in the form of a nozzle. The depth of pool 56 may be set by an overflow weir or spillover edge 82 formed in head or end wall 70. Nozzle 80 communicates at an upstream end with chamber 74 and is directed in an at least partially circumferential direction opposite to the direction of bowl rotation, to provide power recovery or torque contribution. Casing 72 and nozzle 80 represent a liquid phase discharge port assembly 84 several of which are disposed at circumferentially spaced locations about head or end wall 70.

It is to be noted that nozzles 60 and 80, as well as other fluid guide members disclosed herein as parts of respective liquid phase discharge port assemblies are linear members defining a liquid phase discharge path having no bends or turns, with a circumferential component oriented in opposition to a direction of rotation of the bowl. This design reduces power losses due to turbulence and circulation eddies. In part because there are no bends or turns along the liquid phase discharge path, turbulence and circulation eddies are reduced, if not eliminated.

As further depicted in FIG. 4C, a baffle system 86 is provided at head or end wall 70 for purposes of conserving power by channeling the flow of liquid effluent at the outlet of nozzle 80. Baffle system 86 includes a stationary case wall 88 spaced from bowl 68 at least in a region of the liquid phase discharge port assemblies 84. Baffle system 86 further includes a first annular stationary baffle 90 disposed between case wall 88 and bowl 68. The jet of liquid phase discharged via nozzle 80 is directed into a compartment or gutter 92 between case wall 88 and baffle 90, thereby preventing impingement of the discharged liquid onto an outer surface of bowl 68 and concomitantly prevent an imparting of kinetic energy to the discharged liquid by the rotating bowl. Baffle system 86 additionally comprises a stationary cylindrical baffle 94 and a second annular baffle 96. Plates 90, 94 and 96 are connected to one another and to case wall 88 to enclose compartment or gutter 92.

FIG. 4D shows a liquid phase discharge port structure 100 wherein a head or end wall 102 of a centrifuge bowl 104 is formed with an outwardly projecting casing portion 106 integral with a cylindrical clarifier portion 107 of bowl 104 and defining a chamber 108 that is an extension of a bowl space 110. A cylindrical slurry pool 112 in bowl 104 has a bay (not separately designated) in chamber or extension 108, that bay being in essential equilibrium with the slurry in pool 112. Casing portion 106 has a shoulder 114 located on a radially outer side. A tubular fluid guide member 116 in the form of a nozzle is mounted to casing portion 106 at shoulder 114. Nozzle 116 communicates at an upstream end with chamber 108 and is directed in an at least partially circumferential direction opposite to the direction of bowl rotation, to provide a reaction torque assisting in bowl rotation.

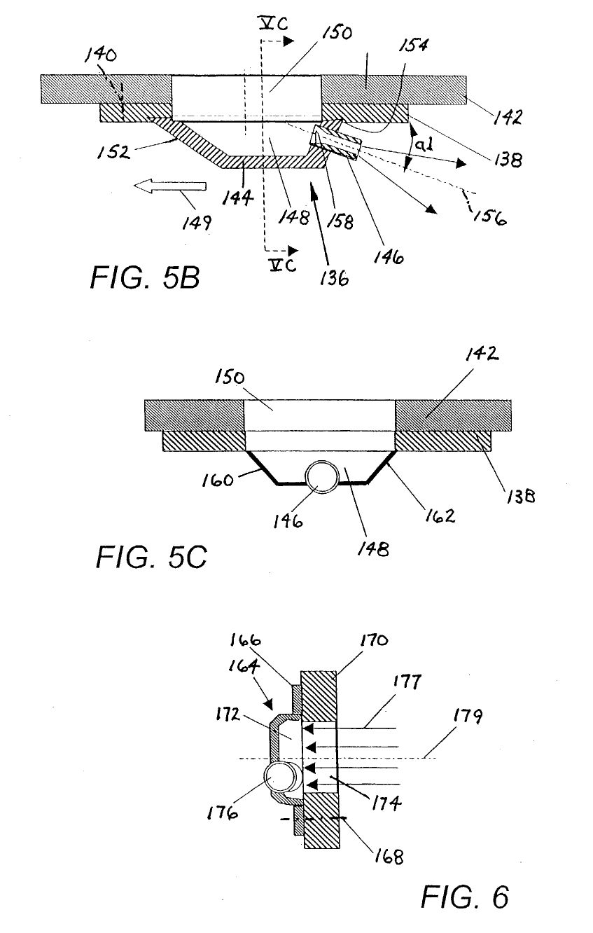

FIG. 5A shows a liquid phase discharge port assembly 120 attached via a flange 122 and bolts 124 to a head or end wall 126 of a centrifuge bowl (not separately shown). The liquid phase discharge port assembly 120 includes a casing 128 connected to flange 122 and a fluid guide member in the form of a nozzle 130 fixed to casing 128 and communicating at an upstream end with a chamber 132 defined by casing 128. Nozzle 130 directs a jet 131 of clarified liquid along a discharge path (not separately designated) having a substantially circumferential direction opposition to the direction of bowl rotation 133. Chamber 132 is equal in width or diameter to an effluent port or opening 134 in bowl head 126.

FIG. 5B shows a liquid phase discharge port assembly 136 rigidly connected via a flange 138 and bolts 140 to a head or end wall 142 of a centrifuge bowl (not separately shown). Port assembly 136 includes a casing 144 fixed to flange 138 and further includes a fluid guide nozzle 146 extending from casing 144 and communicating at an upstream end with a chamber 148 enclosed by the casing. Nozzle 146 directs a jet of clarified liquid in a substantially circumferential direction opposition to the direction of bowl rotation 149. Chamber 148 is equal in width or diameter to an effluent port or opening 150 in bowl head 142. Casing 144 has an exterior that is aerodynamic profiled, including a slanting front face 152 and a slightly inclined rear face 154. Nozzle 146 protrudes slightly beyond the rear face 154 of casing 144. Also, nozzle 146 has an axis 156 oriented at an angle al relative to flange 138 and bowl head 142. Nozzle 146 is provided at its upstream end with a chamfer 158 to provide a smooth entrance of liquid to the nozzle, thereby reducing additional pressure loss due to eddies and secondary flow that arise from an abrupt transition in diameter of the fluid passageway.

FIG. 5C illustrates that the side profile of casing 144 is also aerodynamically shaped. Casing 144 has lateral surfaces 160 and 162 that are inclined or slanted relative to flange 138 and bowl head 142.

As will be apparent from discussion below, liquid phase discharge port assemblies 120 and 136 may include weir plates, instead of flanges 122 and 138, for removably attaching casings 128 and 144 to bowl heads 126 and 142.

FIG. 6 shows a low profile chamber nozzle design where flow is in equilibrium with the pool liquid. A stubby casing 164 having an aerodynamic contour is connected via a flange 166 and bolts 168 to a head or end wall 170 of a decanter bowl (not separately designated). The casing defines a cavity or chamber 172 communicating with a slurry pool (not shown) via an opening or port 174 in the bowl head 170 and with an upstream end of a nozzle 176 pointed substantially in a circumferential direction opposite to the direction of bowl rotation. The low profile design of casing 164 reduces the interference and reacceleration of the discharged mist. Also flow does not need to converge as it passes through port 174 and chamber 172. Instead, clarified liquid flows along straight streamlines 177 parallel to an axis 179 of opening or port 174. Also, as in the case of at least most of the liquid phase discharge port assemblies disclosed herein, the flow does not need to make a 90-degree turn. Instead, flow is directed from the respective casing chamber along a linear path with a significant circumferential component. The liquid phase discharge port assembly designs disclosed herein minimize pressure drop.

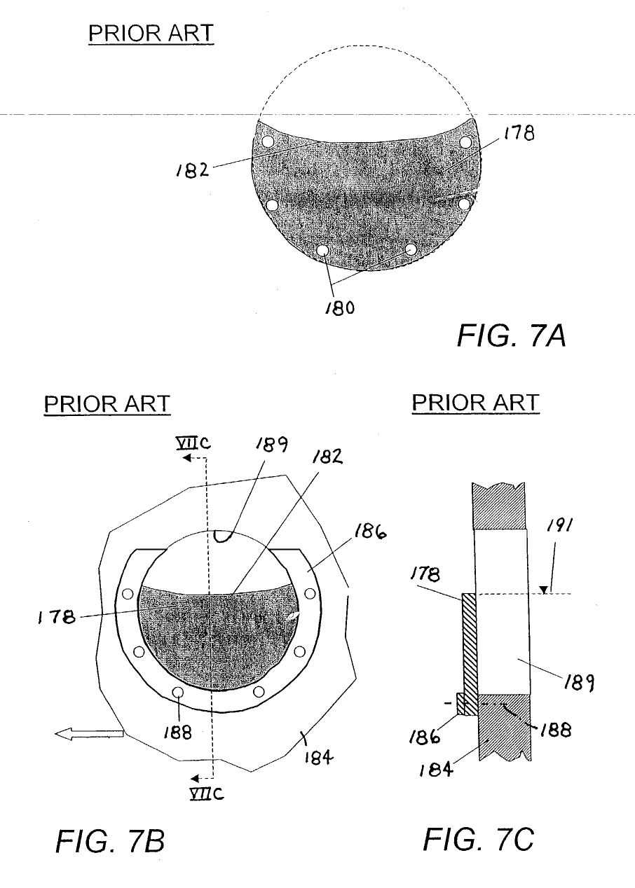

FIG. 7A shows a prior art weir plate 178 provided along a periphery with bolt holes 180. Weir plate 178 is formed with an arcuate edge 182 along one side for setting the pool level in a cylindrical clarifier. FIG. 7B shows weir plate 178 fixed to a bowl head 184 via a retainer ring 186 and bolts 188 so that the weir plate partially covers an opening or port 189 in bowl head 184. FIG. 7C shows weir plate 178 in a section taken in a radial plane through the axis of the machine and indicates a pool surface level 191.

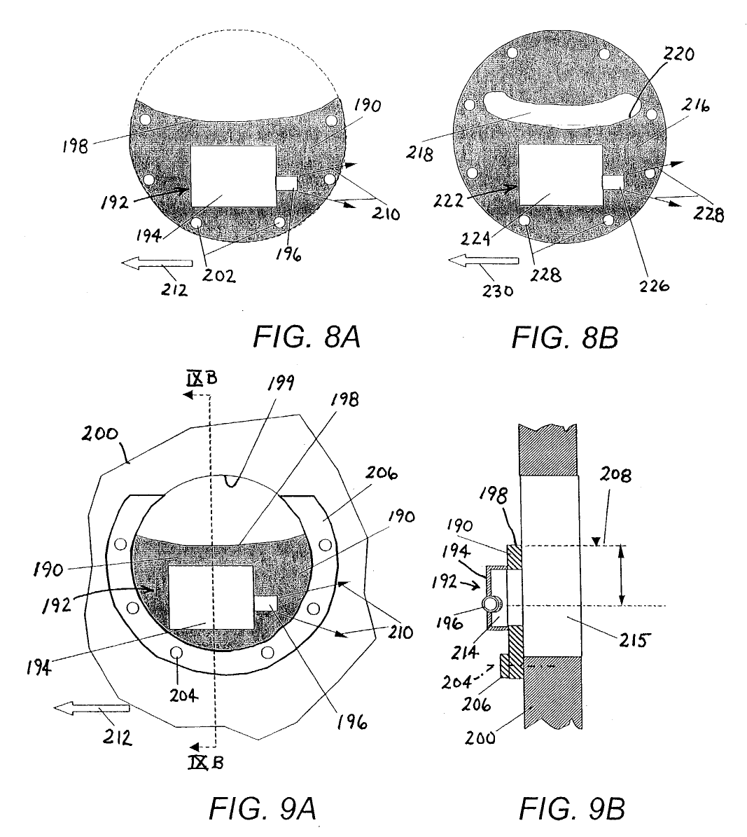

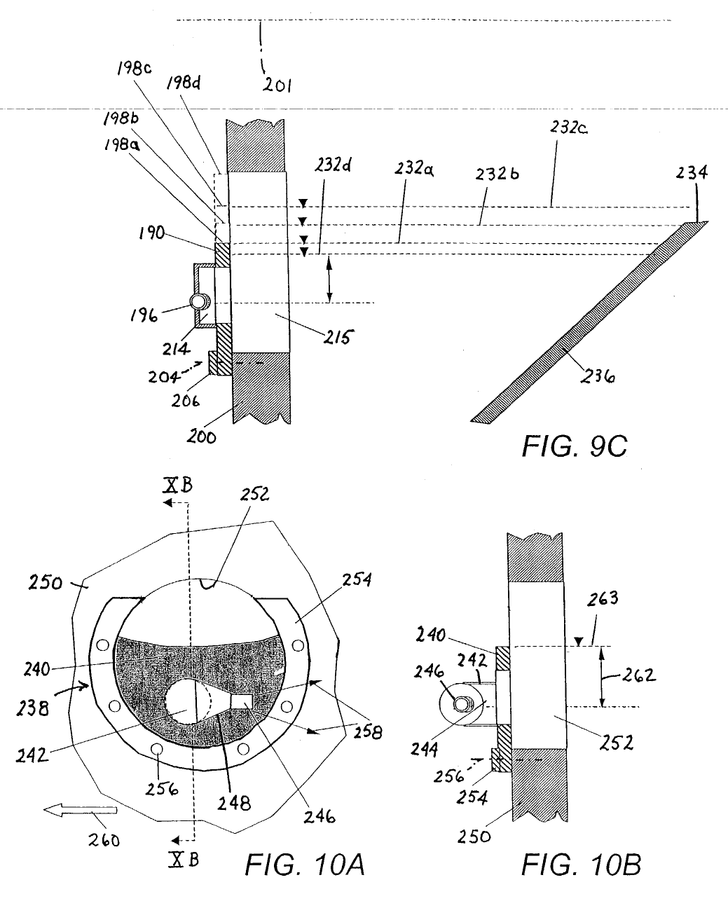

As illustrated in FIG. 8A, a weir plate 190 is provided with a power recovery device 192 comprising a casing 194 and a tubular fluid guide member in the form of a nozzle 196 fastened (welded or screwed) to the casing. Weir plate 190 has an arcuate edge 198. After an attachment of weir plate 190 over an opening 199 in a bowl head 200 (FIGS. 9A, 9B) via bolt holes 202, bolts 204, and a retainer ring 206, edge 198 defines a maximum pool level 208, while nozzle 196 defines a liquid phase discharge path 210 oriented in an at least partially circumferential direction opposite the direction of bowl rotation 212. As shown in FIG. 9B, casing 194 defines a chamber 214 which communicates on one side via a port or opening 215 with a slurry pool in the centrifuge bowl (not separately designated) and on another side with nozzle 196 at an upstream end thereof.

It should also be noted that the retainer ring could be replaced with a thicker weir plate in which bolts countersunk in the weir plate hold the weir to the bowl head. Also given the thickness, a spacious chamber or cavity can be built into the thick weir plate, which is in communication with the liquid pool in the bowl.

As depicted in FIG. 8B, a modified weir plate 216 is formed with an approximately elliptical slot or cutout 218 where one edge 220 defines a pool spillover radius. Weir plate 216 is provided with a power recovery device 222 comprising a chamber-enclosing casing 224 and a tubular fluid guide member in the form of a nozzle 226 welded to the casing. Upon an attachment of weir plate 216 to a bowl head via bolt holes 228, edge 220 defines the maximum pool level, while nozzle 226 defines a liquid phase discharge path 228 oriented in an at least partially circumferential direction opposite the direction of bowl rotation 230.

FIG. 9C shows the same structure as FIG. 9B but indicates that spillover edge 198 may be disposed at different radial locations 198a, 198b, 198c relative to a machine axis 201 (e.g., with respective sizes of weir plate 190) to create different pool levels 232a, 232b, 232c relative to a cake spill or discharge point 234 at an upper end of a conical beach 236 of the centrifuge bowl (not separately designated). When nozzle 196 has a sufficiently large cross-sectional area, a pool level 232d can be set that is below (radially outside of) the spill edge location 198a of the weir plate 190, in which the pool is far below the spill point 234 of beach 236, resulting in a large dry beach section. If the cross-sectional area of nozzle 196 is reduced, the pool can reach level 232a in which the pool is level with spillover edge 198 of weir plate 190 at location 198a and in which the dry portion of the conical beach 236 is reduced. An even taller weir can be used, where spillover edge 198 has radial location 198b, and if nozzle 196 then has a smaller cross-sectional area, the pool can attain level 198b, which is at approximately the same radius as cake spill point 234, reducing the dry beach to zero. A deeper pool level 232c that is above (radially inward of) the conical beach spill point 234 can be attained with a still taller weir, where spillover edge 198 is at radial location 198c, using hydrostatic liquid head to assist discharge of the underflow in the area of the conical beach 236. It is to be noted that weirs with different spill radii (different spillover edge locations 198a, 198b, 198c) involve weir plates 190 of different sizes and inasmuch as casings 194 and nozzles 196 are integral with weir plates 190, different weir plate-chamber nozzle geometries are used. As indicated at 198d in FIG. 9C, the weir can completely block the port 215 of the bowl head 200 allowing no-overflow provision other than flow through the nozzles 196. Obviously, chamber and casing, nozzles (different shape and discharge diameter), and weir plate can all be separate components that can be assembled in various combinations to achieve optimal process function.

It is to be noted that other forms of a power recovery device may be provided on a weir plate. For instance, the power recovery device may take the form of a set of L-shaped parallel vanes each having a first section extending in a radial direction and a second section extending in a circumferential direction, to guide exiting clarified liquid phase first in a radial direction and then in a circumferential direction opposite to the direction of bowl rotation. Alternatively, the power recovery device may take the form of an elbow having an upstream portion protruding perpendicularly to the weir plate and a downstream portion oriented generally parallel (or at an acute angle) relative to the weir plate, to guide exiting clarified liquid phase first in an axial direction and then in an at least partially circumferential direction opposite to the direction of bowl rotation.

It is to be noted further that casings 194 and 224 may be provided with an aerodynamic profile, as discussed above with reference to FIGS. 5A, 5B, and 5C. In addition, nozzles 196 and 226 may be oriented at an acute angle relative to the respective weir plate 190 and 216 (and the bowl head wall 200, after installation of the weir plate with power recovery device).

As illustrated in FIGS. 10A and 10B, a liquid phase discharge port assembly 238 includes a weir plate 240 provided with a substantially cylindrically shaped casing 242 defining a chamber 244 and bearing a fluid guide in the form of a nozzle 246 having a substantially tapered upstream portion 248. It is to be noted that nozzle 246 has such a small cross-sectional area relative to that of casing 242 that flow velocity through chamber 244 is slow and the liquid therein is in substantial equilibrium with the slurry pool. As with all of the chamber-nozzle designs disclosed herein, this design reduces power losses due to turbulence and circulation eddies. There are no bends or turns along a liquid phase discharge path where the liquid is flowing at a substantial speed relative to the slurry pool. Thus, turbulence and circulation eddies are reduced, if not eliminated.

Weir plate 240 is connected to a bowl head 250 over a port or opening 252 therein via a retaining ring 254 and bolts 256. Nozzle 246 is oriented so that a jet of discharged liquid has a trajectory or path 258 extending in an at least partially, and preferably substantially, circumferential direction opposed to the direction of bowl rotation 260. Liquid phase discharge port assembly 238 converts a pressure head 262 into kinetic energy to discharge the high jet velocity along trajectory or path 258. Liquid head 262 corresponds to the difference in radial locations between an inner surface or level 263 of a slurry pool (not separately shown) and nozzle 246. This liquid head translates to a pressure difference in the centrifugal gravity field.

The embodiment of FIGS. 10A and 10B illustrate a design principle underlying other embodiments of a liquid phase discharge port assembly disclosed herein. The flow path of the clarified liquid is such that the liquid remains ineffective equilibrium with the slurry pool (low velocity flow) until the liquid enters a nozzle or other fluid guide having a small cross-sectional diameter relative to any cross-section of the flow taken upstream of the nozzle or flow guide. Once the liquid enters the nozzle or flow guide, the direction of flow is linear, along a trajectory or path having a significant component opposite to the direction of bowl rotation.

It is to be noted that the bowl head ports disclosed herein, e.g., port 134, 150, 215, 252, etc., may be considered as part of the respective chambers 132, 148, 214, and 244, etc., of the liquid phase discharge port assemblies 120, 136, 192, 238, etc. This viewpoint is pertinent because the bowl head ports 134, 150, 215, 252, etc., are contiguous with the respective chambers 132, 148, 214, and 244, etc., and large enough to support the contained liquid in equilibrium with the slurry pool.

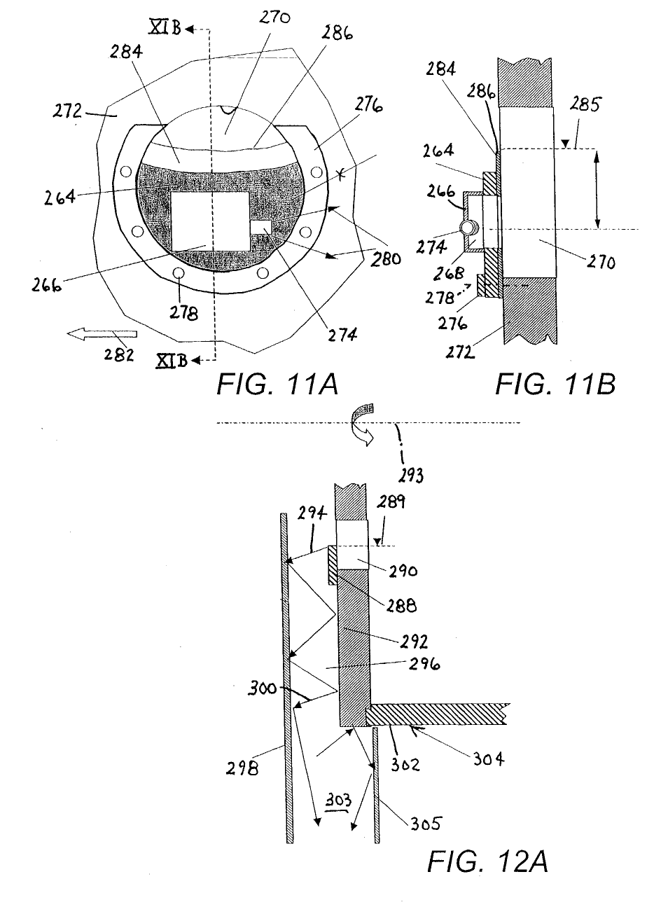

FIGS. 11A and 11B shows an adjustable mechanism for adjusting the spill of a weir plate 264.

Plate 264 carries a casing 266 projecting from one side thereof to define a chamber 268 communicating on the one hand with an opening or port 270 in a centrifuge bowl head 272 and on another hand with a nozzle 274. Weir plate 264 is connected to bowl head 272 via a retainer ring 276 and bolts 278. Upon the fixing of weir plate 264 to bowl head 272, nozzle 274 is oriented to eject a jet of clarified liquid along a trajectory or path 280 extending in at least partially in a circumferential direction opposite to the direction 282 of bowl rotation. The liquid phase discharge port assembly of FIGS. 11A and 11B includes a weir plate extension or insert 284 that is clamped between weir plate 264 and bowl head 272. Extension or insert 284 is positioned on a radially inward side of weir plate 264 (closer to the machine rotation axis) over opening or port 270 so that the radius of the pool surface 285 is defined by an edge 286 of the extension or insert.

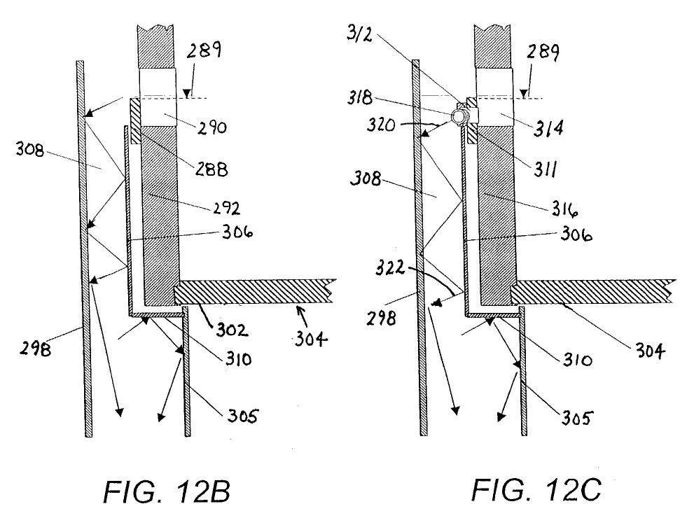

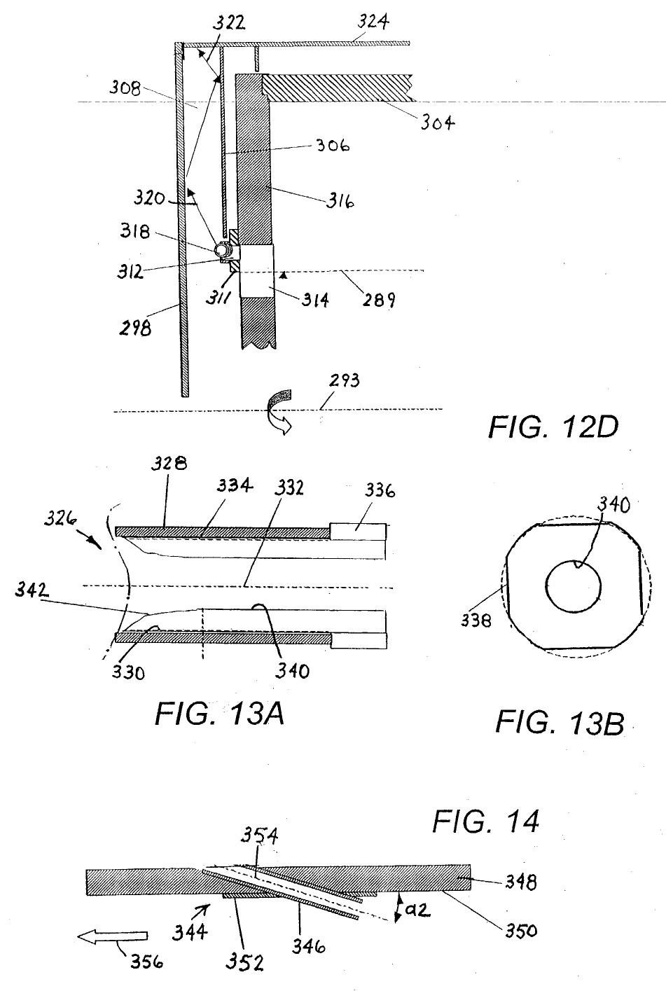

FIG. 12A is a sectional view of a conventional centrifuge with a weir plate 288 disposed over an opening 290 in a bowl head 292 to control the location of a pool level 289. Bowl head 292 is an end wall of a bowl 304 rotatable about a machine axis 293. As indicated by a first arrow 294, effluent liquid is discharged into a space 296 between a case wall 298 and bowl head 292. As indicated by additional arrows 300, the discharged liquid hits the case wall 298 and bounces back towards the bowl head 292 to be re-accelerated thereby. The discharged liquid also hits an outer cylindrical surface 302 of the bowl 304 and is further reaccelerated. The liquid is drained away along a channel 303 between case wall 298 and a baffle 305 parallel thereto.

FIG. 12B shows a baffle system installed in the centrifuge assembly of FIG. 12A for purposes of conserving energy. An annular baffle 306 is provided alongside and parallel to bowl head 292 to establish, with case wall 298, a compartment or gutter 308 that catches the liquid effluent as it is discharged through opening 290. Case wall 298 defines an outer surface or panel of compartment or gutter 308 and may take the form of an outer baffle. The baffle system includes another baffle 310 that in part is cylindrical and functions to shield the flow from contacting the outer cylindrical surface 302 of bowl 304 to prevent reacceleration of the discharged liquid thereby. Baffles 306 and 310 prevent discharged effluent liquid from recontacting any rotating surface. Case wall or outer panel 298 and baffle 306 may be planar or contoured members.

FIG. 12C shows the baffle system of FIG. 12B with a chamber nozzle system including a weir plate 311 with a cavity or chamber 312 communicating with a cylindrical slurry pool (not shown) in a centrifuge bowl 304 via a port 314 in a bowl head or end wall 316. A nozzle 318 provided on weir plate 311 guides clarified liquid from chamber 312 along a linear path 320 having no turns or bends into compartment or gutter 308. Inside the compartment, the liquid is deflected by baffles 306 and 310 away from bowl 304 and particularly away from bowl head 316, as indicated by arrows 322.

FIG. 12D shows an upper half of the baffle system of FIG. 12C, wherein flow discharged from nozzle 318 is guided by case wall 298 and baffle 306 toward a circumferential case wall 324. The clarified liquid is trapped in compartment or gutter 308 and is channeled along wall 324 to drain at a lower side of the machine assembly.

FIG. 13A depicts a nozzle assembly 326 utilizable in any discharge port assembly disclosed herein. A casing (not separately designated) includes a barrel or pipe stub 328 provided along an internal surface with a screw thread 330. A nozzle member 332 is formed along an inner side with a tubular lumen or channel 340 that is tapered or chamfered at one end in a smooth entrance profile 342 for minimizing, if not eliminating, turbulence and circulation eddies during fluid acceleration. Nozzle member 332 is screwed into barrel or pipe stub 328 and is formed at one end with an external screw thread 334 and at an opposite end with a head or collar 336 to rest on the end of the barrel or pipe stub 328. As depicted in FIG. 13B, head 336 is provided with one or more pairs of opposing flats or land surfaces 338 for engagement by a wrench (not shown) during an installation or removal process.

As illustrated in FIG. 14, a simplified liquid phase discharge port assembly 344 includes a tubular flow guide 346 such as a nozzle inserted through a centrifuge bowl head 348 at an angle a2 with respect to the head and particularly with respect to an outer surface 350 thereof. Nozzle 346 may be fastened to bowl head 348 via a flange 352 lying along outer surface 350. A weir plate (not shown) can be used in place of the flange for mounting the tubular flow guide 346 similar to the arrangement shown in FIG. 8A or 8B. In that case, the weir plate and the bowl head 348 together define a chamber (not shown) containing liquid in equilibrium with the slurry pool. Alternatively, the equilibrium chamber (not shown) may be formed essentially entirely in the bowl head 348, with the nozzle 346 extending through the bowl head to the equilibrium chamber in the manner shown in FIG. 14. Nozzle 346 defines a linear liquid phase discharge trajectory or path 354 extending in a direction at least partially opposed to a direction of rotation 356 of the centrifuge bowl (not separately designated).

Pursuant to a design principle discussed above, trajectory or flow path 354 extends from a chamber where the clarified liquid is in effective essential equilibrium with the slurry pool until the liquid enters nozzle 346. The chamber is the clarifier chamber of the centrifuge, and the liquid just upstream of nozzle 346 is in equilibrium with the slurry pool because the liquid is in the slurry pool. Alternatively the chamber can be a cavity or port in the bowl head such as shown in FIGS. 5A, 5B, 5C, 6, 9B, etc. At any rate, nozzle 346 has a small cross-sectional diameter relative to the clarifier chamber. Once the liquid enters nozzle 346, the direction of flow is linear, along trajectory or path 354.

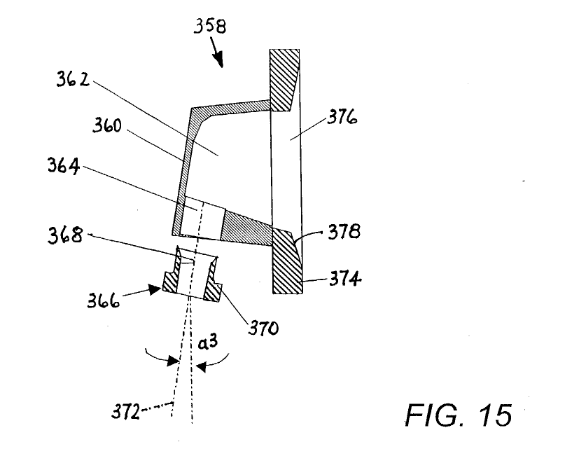

FIG. 15 depicts a liquid phase discharge port assembly 358 including a casing 360 in the form of a block of metal machined to incorporate a relatively large chamber 362 and a linear fluid guide 364 communicating with one another. A nozzle member 366 is inserted into fluid guide 364 and is attached to casing 360 via interleaved screw threads (not shown) or other means. Nozzle member 366 has a tapered or chamfered inlet surface 368 at one end and a flange or shoulder 370 at an opposite end. Flange or shoulder 370 abuts against an outer surface (not designated) of casing 360. Fluid guide 364 and nozzle member 366 direct a jet of liquid phase along a discharge path or trajectory 372 that is substantially circumferentially oriented and substantially opposite to the direction of bowl rotation. More specifically, discharge path or trajectory 372 subtends an angle a3 of between about 10° and 20° and preferably about 15° with respect to a bowl head (not shown) to which port assembly 358 is attached. Port assembly 358 also includes a weir plate 374 provided with an opening or port 376 communicating on the one side with a slurry pool in a centrifuge bowl and on the other side with chamber 362. Opening or port is formed with a tapered or chamfered inlet surface 378 for facilitating a smooth flow.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A rotating machine comprising:
a bowl rotatable about an axis to generate a cylindrical pool of a feed slurry, said bowl having a heavy phase discharge port; and
at least one liquid phase discharge port assembly provided on said bowl, said discharge port assembly including at least one fluid guide member mounted at least indirectly to said bowl to define a liquid phase discharge path having no bends or turns, with a circumferential component oriented in opposition to a direction of rotation of said bowl.

2. The rotating machine defined in claim 1 wherein said bowl includes a bowl head or end wall disposed in a plane oriented substantially perpendicularly to an axis of rotation of said bowl, said liquid phase discharge port assembly including a casing disposed on said head or end wall to define a chamber in fluid communication with said pool, said fluid guide member being connected to said casing and communicating with said chamber.

3. The rotating machine defined in claim 2 wherein said casing is provided on a weir plate removably fastened to said head or end wall.

4. The rotating machine defined in claim 3 wherein said weir plate has an edge defining at least one pool spill radius.

5. The rotating machine defined in claim 4 wherein said edge is arcuate.

6. The rotating machine defined in claim 4 wherein said weir plate has at least one cutout, said edge is part of an edge defining said cutout.

7. The rotating machine defined in claim 3 wherein said liquid phase discharge port assembly includes an insert plate disposed adjacent to said weir plate and having an edge defining at least one pool spill radius, said insert plate having an adjustable position relative to said weir plate and said head or end wall, whereby the pool spill radius may be adjusted.

8. The rotating machine defined in claim 3 wherein said casing is removably fastened to said weir plate and is replaceable.

9. The rotating machine defined in claim 2 wherein said fluid guide member is disposed on said casing so that said liquid phase discharge path is oriented at an acute angle to said plane.

10. The rotating machine defined in claim 9 wherein said angle is less than 45 degrees.

11. The rotating machine defined in claim 9 wherein said angle is between 10 and 20 degrees.

12. The rotating machine defined in claim 2 wherein said casing is provided with an aerodynamic contour or profile.

13. The rotating machine defined in claim 12 wherein said aerodynamic contour or profile includes an outer surface of said casing oriented at an acute angle relative to an outer surface of said head or end wall.

14. The rotating machine defined in claim 2 wherein said chamber has such a size, relative to a passageway of said fluid guide member, that fluid in said chamber is in substantial equilibrium with said pool.

15. The rotating machine defined in claim 2 wherein said casing is connected directly and rigidly to said head or end wall so as to be integral therewith.

16. The rotating machine defined in claim 2 wherein said chamber is an extension of said pool, said casing defining a shoulder on said head or end wall, said fluid guide member being connected to said casing at said shoulder.

17. The rotating machine defined in claim 2 wherein said casing has an inner wall on a radially outer side of said chamber, said inner wall being sloped down towards said pool to facilitate self-cleaning of said chamber from sediment deposit.

18. The rotating machine defined in claim 2 wherein said casing is made of wear resistant material.

19. The rotating machine defined in claim 2 wherein said casing is removably mounted to said bowl.

20. The rotating machine defined in claim 2 wherein said fluid guide member is a nozzle.

21. The rotating machine defined in claim 2 wherein said fluid guide member is removably fastened to said casing and is replaceable.

22. The rotating machine defined in claim 1 wherein said fluid guide member is a nozzle provided with a passageway of gradually decreasing diameter to reduce pressure loss.

23. The rotating machine defined in claim 22 wherein said passageway has a downstream section of substantially constant cross-sectional area and of sufficient length so that discharging liquid is accelerated to a final discharge velocity so as to obtain a coherent jet of discharging liquid with reduced spreading.

24. The rotating machine defined in claim 1 wherein said fluid guide member is removably mounted to said bowl.

25. The rotating machine defined in claim 1 wherein said fluid guide member is made of wear resistant material.

26. The rotating machine defined in claim 1 wherein said bowl includes a head or end wall disposed in a plane oriented substantially perpendicularly to an axis of rotation of said bowl, said fluid guide member being disposed on said head or end wall so that said liquid phase discharge path is oriented at an acute angle to said plane.

27. The rotating machine defined in claim 1, further comprising a stationary case wall disposed around said bowl at least in a region of said liquid phase discharge port assembly, said stationary case wall being spaced from said bowl, additionally comprising at least one stationary baffle disposed between said case wall and said bowl, said liquid phase discharge path being directed into a compartment or gutter between said case wall and said baffle, thereby preventing impingement of discharged liquid onto an outer surface of said bowl and concomitantly preventing an imparting of kinetic energy to the discharged liquid by the rotating bowl.

28. A rotating machine comprising:
a bowl rotatable about an axis to generate a cylindrical pool of a feed slurry, said bowl having a heavy phase discharge port and a head or end wall; and
at least one liquid phase discharge port assembly carried by said head or end wall, at least one of said liquid phase port assembly and said head or end wall defining a chamber communicating with said pool, said port assembly including a fluid guide member mounted at least indirectly to said bowl and communicating with said chamber, said fluid guide member extending at least partially in a circumferential direction opposed to a direction of rotation of said bowl.

29. The rotating machine defined in claim 28 wherein said liquid phase discharge port assembly includes a weir plate removably fastened to said head or end wall, said weir plate defining said chamber.

30. The rotating machine defined in claim 29 wherein said weir plate has an edge defining at least one pool spill radius.

31. The rotating machine defined in claim 30 wherein said edge is arcuate.

32. The rotating machine defined in claim 30 wherein said weir plate has at least one cutout, said edge is part of an edge defining said cutout.

33. The rotating machine defined in claim 29 wherein said liquid phase discharge port assembly further includes at least one insert plate disposed adjacent to said weir plate and having an edge defining at least one pool spill radius, said insert plate being movably mounted to said weir plate and said head or end wall, whereby the pool spill radius may be adjusted.

34. The rotating machine defined in claim 28 wherein said liquid phase discharge port assembly includes a casing connected to said head or end wall and defining said chamber, said casing being connected to said head or end wall, said fluid guide member being attached to said casing.

35. The rotating machine defined in claim 34 wherein said casing is provided with an aerodynamic contour or profile.

36. The rotating machine defined in claim 35 wherein said aerodynamic contour or profile includes an outer surface of said casing oriented at an acute angle relative to an outer surface of said head or end wall.

37. The rotating machine defined in claim 34 wherein said chamber is an extension of said pool, said casing defining a shoulder on said head or end wall, said fluid guide member being connected to said casing at said shoulder.

38. The rotating machine defined in claim 34 wherein said casing has an inner wall on a radially outer side of said chamber, said inner wall being sloped down towards said pool to facilitate self-cleaning of said chamber.

39. The rotating machine defined in claim 34 wherein said fluid guide member is a nozzle.

40. The rotating machine defined in claim 28 wherein said fluid guide member is oriented at an acute angle to said head or end wall.

41. The rotating machine defined in claim 40 wherein said angle is less than 45 degrees.

42. The rotating machine defined in claim 40 wherein said angle is between 10 and 20 degrees.

43. The rotating machine defined in claim 28 wherein said fluid guide member is a nozzle provided with a passageway of gradually decreasing diameter to reduce pressure loss.

44. The rotating machine defined in claim 43 wherein said passageway has a downstream section of substantially constant cross-sectional area and of sufficient length so that discharging liquid is accelerated to a final discharge velocity so as to obtain a coherent jet of discharging liquid with reduced spreading.

45. The rotating machine defined in claim 28 wherein said chamber is formed by a casing made of wear resistant material.

46. The rotating machine defined in claim 28 wherein said chamber is formed by a casing removably mounted to said bowl.

47. The rotating machine defined in claim 28 wherein said chamber has such a large size, relative to a passageway of said fluid guide member, that fluid in said chamber is in substantial equilibrium with said pool.

48. The rotating machine defined in claim 28, further comprising a stationary case wall disposed around said bowl at least in a region of said liquid phase discharge port assembly, said stationary case wall being spaced from said bowl, additionally comprising at least one stationary baffle disposed between said case wall and said bowl, said fluid guide member pointing toward a compartment or gutter between said case wall and said baffle to direct liquid flow into said compartment or gutter, thereby preventing impingement of discharged liquid onto an outer surface of said bowl and concomitantly preventing an imparting of kinetic energy to the discharged liquid by the rotating bowl.

49. The rotating machine defined in claim 28 wherein said chamber is on a side of said head or end wall opposite said pool.

50. The rotating machine defined in claim 28 wherein said chamber is inside said head or end wall.

51. The rotating machine defined in claim 28 wherein a large opening or port in said head or end wall at least partially defines said chamber.

52. A liquid-phase discharge port assembly for a rotating machine producing a liquid phase from a feed slurry, comprising:
a weir plate adapted for placement over a discharge opening in a bowl of said rotating machine; and
at least one power recovery device attached to said weir plate.

53. The discharge port assembly defined in claim 52 wherein said weir plate has an edge defining at least one pool spill radius.

54. The discharge port assembly defined in claim 53 wherein said edge is arcuate.

55. The discharge port assembly defined in claim 53 wherein said weir plate has at least one cutout, said edge is part of an edge defining said cutout.

56. The discharge port assembly defined in claim 52 wherein said power recovery device includes a straight fluid guide member member.

57. The discharge port assembly defined in claim 56, further comprising a casing defining a chamber along said one side of said weir plate, said fluid guide member communicating at an upstream end with said chamber.

58. The discharge port assembly defined in claim 57 wherein said chamber has such a size, relative to a passageway of said fluid guide member, that fluid in said chamber flows smoothly, without significant pressure loss due to turbulence and circulation eddies, during a discharge of fluid through said fluid guide member.

59. The discharge port assembly defined in claim 57 wherein said fluid guide member is attached to said casing.

60. The discharge port assembly defined in claim 57 wherein said casing is provided with an aerodynamic contour or profile.

61. The discharge port assembly defined in claim 56 wherein said fluid guide member is a nozzle.

62. The discharge port assembly defined in claim 56 wherein said fluid guide member is made of wear resistant material.

63. The discharge port assembly defined in claim 52 wherein said power recovery device is made of wear resistant material.

64. The discharge port assembly defined in claim 52 wherein said weir plate covers said discharge opening completely, whereby discharging liquid phase must exit through said power recovery device.

65. The discharge port assembly defined in claim 52, further comprising at least one insert plate disposable adjacent to said weir plate and having an edge defining at least one pool spill radius, said insert plate being movably disposed relative to said weir plate and said head or end wall, whereby the pool spill radius may be adjusted.

66. A liquid-phase discharge port assembly for a rotating machine producing a liquid phase from a feed slurry, comprising:
a casing adapted for attachment to a bowl of said rotating machine to define a chamber communicating with a pool of feed slurry in said bowl; and
at least one fluid guide member rigidly mounted to said casing so as to communicate with said chamber, said chamber having such a size, relative to a passageway of said fluid guide member, that fluid in said chamber is in substantial equilibrium with said pool.

67. The discharge port assembly defined in claim 66 wherein said fluid guide member is attached to said casing.

68. The discharge port assembly defined in claim 66 wherein said fluid guide member includes at least one linear tube segment extending from said weir plate to define a liquid phase discharge path having no bends or turns.

69. The discharge port assembly defined in claim 66 wherein said casing is provided with an aerodynamic contour or profile.

70. The discharge port assembly defined in claim 66, further comprising means for mounting said casing and said fluid guide member to the bowl of said rotating machine.

71. A liquid phase discharge system for a rotating machine, comprising:
at least one effluent discharge port on a bowl of the rotating machine;
a compartment or gutter provided at said bowl at least in a region of said effluent discharge port, said compartment or gutter being defined in part by a stationary outer panel spaced from an end wall of said bowl;
at least one stationary baffle disposed between said panel and said bowl, said stationary baffle and said panel defining said stationary gutter for receiving liquid phase discharged from said bowl via said discharge port, thereby preventing impingement of the discharged liquid phase onto an outer surface of said bowl and concomitantly preventing an imparting of kinetic energy to the discharged liquid by the rotating bowl.

72. The system defined in claim 71 where said baffle is disposed in a plane oriented substantially perpendicularly to a rotation axis of said bowl.

73. The system defined in claim 72 where said baffle extends in a radial direction outwardly from a discharge opening of said discharge device.

74. The system defined in claim 73, further comprising an additional stationary baffle disposed at a radially outer end of said at least one stationary baffle, said additional stationary baffle having an arcuate shape.

75. The system defined in claim 73, further comprising an additional stationary baffle attached to said at least one stationary baffle.

76. The system defined in claim 71 wherein at least one of said panel and said baffle is made at least partially of a shock-absorbing material that captures energy from the discharged liquid phase.

77. The system defined in claim 71 wherein said shock-absorbing material is an elastomeric material.

78. The system defined in claim 71 wherein said panel is a stationary case wall.

79. The system defined in claim 71 wherein said panel is a stationary baffle.

80. A method for operating a rotating machine, comprising:
feeding a slurry to a bowl;
rotating said bowl about an axis to generate a cylindrical pool of the feed slurry;
during the rotating of said bowl, discharging a heavy phase from said bowl via a discharge port; and
during the rotating of said bowl, discharging a liquid phase through a fluid guide member on said bowl and along a liquid phase discharge path having no bends or turns, with a circumferential component oriented in opposition to a direction of rotation of said bowl.

81. A method for operating a rotating machine, producing a liquid phase from a feed slurry, comprising:
providing a liquid-phase discharge port assembly including a weir plate;
attaching said weir plate to a bowl of the rotating machine over a discharge opening in said bowl;
feeding a slurry to said bowl;
rotating said bowl about an axis to generate a cylindrical pool of the feed slurry;
during the rotating of said bowl, discharging a heavy phase from said bowl via a discharge port; and
during the rotating of said bowl, discharging a liquid phase through at least one power recovery device attached to said weir plate.

82. A method for operating a rotating machine, comprising:
feeding a slurry to said bowl;
rotating said bowl about an axis to generate a cylindrical pool of the feed slurry;
during the rotating of said bowl, discharging a heavy phase from said bowl via a discharge port; and
during the rotating of said bowl, discharging a liquid phase into a gutter defined between a stationary panel spaced from said bowl and at least one stationary baffle disposed between said panel and said bowl, thereby preventing impingement of the discharged liquid phase onto an outer surface of said bowl and concomitantly preventing an imparting of kinetic energy to the discharged liquid by the rotating bowl.
